(19) United States
(12) Patent Application Publication
(10) Pub. No.: US 2017/0008817 A1
(43) Pub. Date: Jan. 12, 2017

(54) COMPATIBILITY AID FOR PESTICIDES IN FERTILIZER COMPOSITIONS

(71) Applicant: RHODIA OPERATIONS, Paris (FR)

(72) Inventors: Neal Ryan, Bensalem, PA (US); Marivi Ortiz-Suarez, Burlington, NJ (US); Zachary Maron, Plainsboro, NJ (US)

(73) Assignee: RHODIA OPERATIONS, Paris (FR)

(21) Appl. No.: 15/205,220

(22) Filed: Jul. 8, 2016

Related U.S. Application Data
(60) Provisional application No. 62/189,855, filed on Jul. 8, 2015.

(51) Int. Cl. C05G 3/02; A01N 47/24; C05B 17/00; A01N 43/54

(52) U.S. Cl. CPC C05G 3/02; A01N 43/54; A01N 47/24; C05B 17/00

(57) ABSTRACT

A stable agricultural composition comprises at least one pesticide, a compatibilizing component comprising at least one of a polyol, a carboxylic-acid containing polymer, a poly(oxy-1,2-ethanediyl)-alpha-C₆₋₂₂alkyl-omega-hydroxy phosphate or salt thereof and/or an alkylpolyglucoside, at least one fertilizer.

### CROSS-REFERENCE TO RELATED APPLICATIONS

This application claims the benefit of U.S. Provisional Patent Application No. 62/189,855 filed Jul. 8, 2015, incorporated herein by reference in its entirety.

### FIELD OF THE INVENTION

The invention relates to stable agricultural pesticide (e.g., fungicide. Insecticide, herbicide) compositions, more particularly to agricultural compositions comprising a stable, compatible, flowable mixture of a strobilurin fungicide and a fertilizer, along with compatibilizing agent.

### BACKGROUND

Many agricultural pesticides, including insecticides, fungicides, herbicides, miticides, and plant growth regulators, are applied in the form of a liquid composition. In addition to the pesticide and a solvent, such liquid compositions typically include one or more adjuvant compounds intended to improve one or more properties of the liquid composition, such as for example, storage stability, ease of handling, pesticide efficacy against target organisms.

Such agricultural pesticide compositions are typically applied to target plants by spraying. Spraying means are typically mounted on aircraft, tractors, ground rigs, irrigation systems or railcars. A spray may also be dispensed from a canister using mechanical means, such as a pump, or chemical means, such as a propellant.

Certain pesticides (for example, fungicides, insecticides, herbicides) and fertilizers are incompatible and, thus, pose significant problems when needing to mix such compounds for field applications. Chloronicontinyl insecticides, as an example, is in general incompatible with fertilizers, specifically, liquid fertilizer compositions. As another example, fungicides and fertilizers are currently both applied in furrow to treat rhizoctonia and provide nutrients respectively. Due to compatibility issues, they cannot apply both products at one time, increasing, for example, the time and cost of application.

Prior solutions involved diluting the mixture substantially, not ideal in many situations, or to apply the treatments to the field separately, which can be costly and time consuming.

There is a continuing interest in agricultural pesticide compositions, more particularly agricultural fungicide compositions, which exhibit improved properties.

### SUMMARY OF THE INVENTION

Strobilurins are nonpolar compounds, have relatively low water solubility, soil mobility, and volatility. In particular, strobilurins are susceptible towards chemical degradation during and after field application. Strobilurins are currently formulated into various usable forms such as emulsifiable concentrates (ECs) and suspension concentrates (SC) that use solvents along with emulsifiers and stabilizers. There is a continuing interest in providing agricultural compositions, which contain a strobilurin active and a fertilizer, in a convenient form that exhibits good handling properties and good stability, in particular, application or field stability.

In one aspect, described herein are stable agricultural compositions comprising:
a compatibilizing component (also herein referred to as “compatibilizing agent”, used interchangeably) selected from: (i) at least one polyol, (ii) at least one carboxylic acid-containing polymer (e.g., polyacrylic acid or salt thereof), (iii) at least one alkylpolyglucoside, and/or (iv) at least one poly(oxy-1,2-ethanediyl)-alpha-C₆₋₂₂alkyl-omega-hydroxy phosphate or salt thereof;
at least one pesticide,
at least one fertilizer, and
optionally, water

In one aspect, described herein are stable agricultural compositions comprising:
a compatibilizing component selected from: (i) at least one polyol and (ii) at least one alkylpolyglucoside;
at least one pesticide,
at least one fertilizer, and
optionally, water.

In one aspect, described herein are stable agricultural compositions comprising:
a compatibilizing component selected from: (i) at least one polyol and (ii) at least one poly(oxy-1,2-ethanediyl)-alpha-C₆₋₂₂alkyl-omega-hydroxy phosphate or salt thereof;
at least one pesticide,
at least one fertilizer, and
optionally, water

In one embodiment, the at least one poly(oxy-1,2-ethanediyl)-alpha-C₆₋₂₂alkyl-omega-hydroxy phosphate or salt thereof is a poly(oxy-1,2-ethanediyl)-alpha-isodecyl-omega-hydroxy phosphate or salt thereof.

In one aspect, described herein are stable agricultural compositions comprising:
a compatibilizing component selected from: (i) at least one polyol and/or (ii) at least one carboxylic acid-containing polymer (e.g., polyacrylic acid or salt thereof);
at least one pesticide, and
at least one fertilizer.

In one embodiment, the polyol is glycerine. In one embodiment, the polyol is a diol, for example, ethylene glycol or propylene glycol. In one embodiment, the carboxylic acid-containing polymer is polyacrylic acid or a salt thereof. In one embodiment, the pesticide is a fungicide. In one particular embodiment, the fungicide is a strobilurin compound.

In one embodiment, the pesticide is a fungicide. In another embodiment, the pesticide is an insecticide. In another embodiment, the pesticide is an herbicide.

In another aspect, described herein are concentrated agricultural compositions, comprising, based on total weight of composition:
from 1 wt % to about 20 wt %, typically, from 1 wt % to about 20 wt % or, alternatively, from 1 wt % to about 5 wt %, of polyol, e.g., glycerine;
from 1 wt % to about 75 wt %, typically, from 1 wt % to about 20 wt % or, alternatively, from 1 wt % to about 5 wt %, of at least one surfactant, e.g., polyacrylic acid or salt thereof, alkylpolyglucoside, or poly(oxy-1,2-ethanediyl)-alpha-C₆₋₂₂alkyl-omega-hydroxy phosphate or salt thereof;
from 1 wt % to about 75 wt %, typically, from 1 wt % to about 20 wt % or, alternatively, from 1 wt % to about 5 wt %, of at least one strobilurin compound, and
from 1 wt % to about 99.9 wt %, typically from 20 wt % to about 99 wt % or from 30 wt % to about 98 wt %, of at least one fertilizer. In one embodiment, the concentrated agricultural composition is a concentrated fungicide composition.

In one embodiment, the polyol is present in an amount (based on total weight of compatibilizing component, which in one embodiment, is a pesticide composition) from 1 wt % to about 75 wt %. In another embodiment, the polyol is present in an amount (based upon total weight of compatibilizing component) from 2 wt % to about 60 wt %. In another embodiment, the polyol is present in an amount (based upon total weight of compatibilizing component) from 10 wt % to about 60 wt %.

In one embodiment, the surfactant is present in an amount (based upon total weight of compatibilizing component) from 0.01 wt % to about 75 wt %. In another embodiment, the surfactant is present in an amount (based upon total weight of compatibilizing component) from 2 wt % to about 60 wt %. In another embodiment, the surfactant is present in an amount (based upon total weight of compatibilizing component) from 10 wt % to about 60 wt %. In one embodiment, the surfactant is selected from at least one of (i) a carboxylic acid-containing polymer (e.g., polyacrylic acid or salt thereof), (ii) an alkylpolyglucoside, (iii) a poly(oxy-1,2-ethanediyl)-alpha-C₆₋₂₂alkyl-omega-hydroxy phosphate or salt thereof, and/or (iv) a poly(oxy-1,2-ethanediyl)-alpha-C₆₋₂₂alkyl-omega-hydroxy sulfate or salt thereof.

In another aspect, described herein are agricultural compositions, comprising, (i) glycerine, (ii) at least one of an alkylpolyglucoside or a poly(oxy-1,2-ethanediyl)-alpha-C₆₋₂₂alkyl-omega-hydroxy phosphate or salt thereof, (iii) at least one strobilurin compound, and (iv) at least one fertilizer.

### BRIEF DESCRIPTION OF THE DRAWINGS

FIG. 1 shows a viscosity vs. temperature stability chart of DV-1 from 0-60° C.

FIG. 2 is a photograph of Candidate A (3% use rate) compatibility aid results.

FIG. 3 is a photograph of Candidate B (3% use rate) compatibility aid results.

FIG. 4 is a photograph of Use rate determination for Candidate A.

FIG. 5 is a photograph of Use rate determination for Candidate B (1.7 to 3.3%)

FIG. 6 is a photograph of Use rate determination for Candidate B (Lower use rate determination)

### DETAILED DESCRIPTION OF INVENTION AND PREFERRED EMBODIMENTS

As used herein, “liquid medium” means a medium that is in the liquid phase at a temperature of 25° C. and a pressure of one atmosphere. The liquid medium may be a non-aqueous liquid medium or an aqueous liquid medium.

As used herein, the term “alkyl” means a saturated straight chain, branched chain, or cyclic hydrocarbon radical, such as for example, methyl, ethyl, n-propyl, iso-propyl, n-butyl, sec-butyl, t-butyl, pentyl, n-hexyl, and cyclohexyl.

As used herein, the term “alkylene” means a divalent saturated straight or branched chain hydrocarbon radical, such as for example, methylene, dimethylene, trimethylene.

As used herein, the term “alkoxy” means an oxy radical that is substituted with an alkyl group, such as for example, methoxy, ethoxy, propoxy, isopropoxy, and butoxy. As used herein in reference to an organic compound, the term “alkoxylated” means that the compound comprises one or more alkoxy or, more typically, poly(alkyleneoxy) moieties, such as, for example a poly(ethyleneoxy), poly(propyleneoxy), or poly(ethlyeneoxypropyleneoxy) moiety and the term “ethoxylated” means that the compound comprises at least one ethoxy or poly(ethyleneoxy) moiety. As used herein in reference to a poly(alkyleneoxy) moiety, the notation “(n)”, wherein n is an integer, indicates the number of alkyleneoxy monomeric units in the poly(alkyleneoxy) moiety.

As used herein, the term “alkenyl” means an unsaturated straight chain, branched chain, or cyclic hydrocarbon radical that contains one or more carbon-carbon double bonds, such as, for example, ethenyl, 1-propenyl, and 2-propenyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, such as, for example, phenoxy, phenyl, methylphenyl, dimethylphenyl, trimethylphenyl, chlorophenyl, trichloromethylphenyl, aminophenyl, and tristyrylphenyl.

As used herein, the term “arylene” means a divalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, such as, for example, phenylene, methylphenylene, trimethylphenylene, aminophenylene and tristyrylphenylene.

As used herein, the term “aralkyl” means an alkyl group substituted with one or more aryl groups, such as, for example, phenylmethyl, phenylethyl, and triphenylmethyl.

As used herein, the term “aralkenyl” means an alkenyl group substituted with an aryl group, such as, for example, phenylethenyl, and phenylpropenyl.

As used herein, the term “aryloxy” means an oxygen radical substituted with an aryl group, such as, for example, phenoxy, methylphenoxy, and trimethylphenoxy.

As used herein, the terminology “(On-Cm)” in reference to an organic group, wherein n and m are each integers, indicates that the group may contain from n carbon atoms to m carbon atoms per group.

In one embodiment, the liquid medium is an aqueous liquid medium. As used herein, the terminology “aqueous medium” means a single phase liquid medium that contains more than a trace amount of water, typically, based on 100 pbw of the aqueous medium, more than 0.1 pbw water. Suitable aqueous media more typically comprise, based on 100 pbw of the aqueous medium, greater than about 5 pbw water, even more typically greater than 10 pbw water. In one embodiment, the aqueous emulsion comprises, based on 100 pbw of the aqueous medium, greater than 40 pbw water, more typically, greater than 50 pbw water. The aqueous medium may, optionally, further comprise water soluble or water miscible components dissolved in the aqueous medium. The terminology “water miscible” as used herein means miscible in all proportions with water. Suitable water miscible organic liquids include, for example, (C₁-C₆)alcohols, such as methanol, ethanol, propanol, and (C₁-C₆)polyols, such as glycerol, ethylene glycol, propylene glycol, and diethylene glycol, The composition of the present invention may, optionally, further comprise one or more water insoluble or water immiscible components, such as a water immiscible organic liquid, wherein the combined aqueous medium and water insoluble or water immiscible components form a micro emulsion, or a multi-phase system such as, for example, an emulsion, a suspension or a suspo-emulsion, in which the aqueous medium is in the form of a discontinuous phase dispersed in a continuous phase of the water insoluble or water immiscible component, or, more typically, the water insoluble or water immiscible component is in the form of a discontinuous phase dispersed in a continuous phase of the aqueous medium.

In one embodiment, the composition of the present invention exhibits a viscosity of less than 10 Pa·s, more typically from about 0.1 to less than 10 Pa·s, and even more typically from about 0.1 to less than 5 Pa·s, at a shear rate of greater than or equal to 10 s⁻¹.

Suitable pesticides are biologically active compounds used to control agricultural pests and include, for example, herbicides, plant growth regulators, crop dessicants, fungicides, bacteriocides, bacteriostats, insecticides, and insect repellents, as well as their water soluble salts and esters. Suitable pesticides include, for example, aryloxyphenoxy-propionate herbicides, such as haloxyfop, cyhalofop, and quizalofop, triazine herbicides such as metribuzin, hexaxinone, or atrazine; sulfonylurea herbicides such as chlorsulfuron; uracils such as lenacil, bromacil, or terbacil; urea herbicides such as linuron, diuron, siduron, or neburon; acetanilide herbicides such as alachlor, or metolachlor; thiocarbamate herbicides such as benthiocarb, triallate; oxadiazolone herbicides such as oxadiazon; isoxazolidone herbicides, phenoxy carboxylic acid herbicides, diphenyl ether herbicides such as fluazifop, acifluorfen, bifenox, or oxyfluorfen; dinitro aniline herbicides such as trifluralin; organophosphonate herbicides such as glufosinate salts and esters and glyphosate salts and esters; dihalobenzonitrile herbicides such as bromoxynil, or ioxynil, benzoic acid herbicides, dipyridilium herbicides such as paraquat, and pyridine and pyridineoxy carboxylic acid herbicides such as clopyralid, fluroxypyr, picloram, triclopyr, and aminopyralid. Suitable fungicides include, for example, nitrilo oxime fungicides such as cymoxanil; imidazole fungicides such as benomyl, carbendazim, or thiophanate-methyl, triazole fungicides such as triadimefon; sulfenamide fungicides, such as captan; dithio-carbamate fungicides such as maneb, mancozeb, or thiram; chloronated aromatic fungicides such as chloroneb; dichloro aniline fungicides such as iprodione, strobilurin fungicides such as kresoxim-methyl, trifloxystrobin or azoxystrobin; chlorothalonil; copper salt fungicides such as copper oxychloride; sulfur; phenylamides; and acylamino fungicides such as metalaxyl or mefenoxam. Suitable insecticides, include, for example, carbamate insecticides, such as methomyl, carbaryl, carbofuran, or aldicarb; organo thiophosphate insecticides such as EPN, isofenphos, isoxathion, chlorpyrifos, or chlormephos, organophosphate insecticides such as terbufos, monocrotophos, or terachlorvinphos; perchlorinated organic insecticides such as methoxychlor, synthetic pyrethroid insecticides such as fenvalerate, abamectin or emamectin benzoate, neonicotinoide insecticides such as thiamethoxam or imidacloprid; pyrethroid insecticides such as lambda-cyhalothrin, cypermethrin or bifenthrin, and oxadiazine insecticides such as indoxacarb, imidachlopryd, or fipronil. Suitable miticides include, for example, propynyl sulfite miticides such as propargite; triazapentadiene miticides such as amitraz; chlorinated aromatic miticides such as chlorobenzilate, or tetradifan; and dinitrophenol miticides such as binapacryl. Suitable nematicides include carbamate nematicides, such as oxamyl.

Pesticide compounds are, in general, referred herein to by the names assigned by the International Organization for Standardization (ISO). ISO common names may be cross-referenced to International Union of Pure and Applied Chemistry (“IUPAC”) and Chemical Abstracts Service (“CAS”) names through a number of sources.

In one embodiment, the pesticide comprises one or more compounds selected from herbicides, plant growth regulators, crop dessicants, fungicides, bacteriocides, bacteriostats, insecticides, miticides, nematocides, insect repellents, and mixtures thereof.

In one aspect, described herein are stable agricultural compositions comprising:
a compatibilizing component selected from: (i) at least one polyol, (ii) at least one carboxylic acid-containing polymer (e.g., polyacrylic acid or salt thereof), (iii) at least one alkylpolyglucoside, and/or (iv) at least one poly(oxy-1,2-ethanediyl)-alpha-C₆₋₂₂alkyl-omega-hydroxy phosphate or salt thereof;
at least one pesticide, and
at least one fertilizer.

In one aspect, described herein are stable agricultural compositions comprising:
a compatibilizing component selected from: (i) at least one polyol, (ii) at least one carboxylic acid-containing polymer (e.g., polyacrylic acid or salt thereof), (iii) at least one alkylpolyglucoside, and/or (iv) at least one poly(oxy-1,2-ethanediyl)-alpha-C₆₋₂₂alkyl-omega-hydroxy phosphate or salt thereof;
at least one pesticide,
at least one fertilizer, and
optionally, water.

In one embodiment, the stable agricultural compositions, comprise, based on total weight of compatibilizing component:
from 10 wt % to about 90 wt %, typically, 20 wt % to 70 wt %, of polyol, e.g., glycerine;
from about 1 wt % to about 40 wt %, typically, from 2 wt % to about 30 wt %, more typically from 10 wt % to 25 wt % of at least one surfactant, e.g., polyacrylic acid or salt thereof, alkylpolyglucoside, or poly(oxy-1,2-ethanediyl)-alpha-C₆₋₂₂alkyl-omega-hydroxy phosphate, sulfate or salt thereof.

In one embodiment, the surfactant is only alkylpolyglucoside. In another embodiment, the surfactant is only poly(oxy-1,2-ethanediyl)-alpha-C₆₋₂₂alkyl-omega-hydroxy phosphate, sulfate or salt thereof. In a further embodiment, the surfactant is a combination of alkylpolyglucoside and poly(oxy-1,2-ethanediyl)-alpha-C₆₋₂₂alkyl-omega-hydroxy phosphate, sulfate or salt thereof.

In one aspect, described herein are stable agricultural compositions comprising:
a compatibilizing component selected from: (i) at least one polyol and (ii) at least one alkylpolyglucoside;
at least one pesticide,
at least one fertilizer, and
optionally, water.

In one aspect, described herein are stable agricultural compositions comprising:
a compatibilizing component selected from: (i) at least one polyol and (ii) at least one poly(oxy-1,2-ethanediyl)-alpha-C₆₋₂₂alkyl-omega-hydroxy phosphate or salt thereof;
at least one pesticide,
at least one fertilizer, and
optionally, water

In one embodiment, the compatibilizing component comprises at least one alkylpolyglucoside surfactant. In one embodiment, the alkylpolyglucoside surfactant comprises one or more compounds according to structure (II):

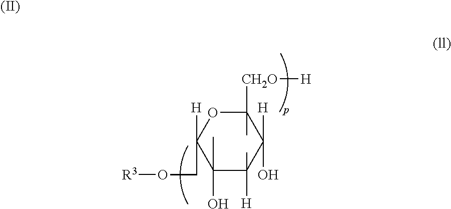

wherein R3 is alkyl, hydroxyalkyl, or aralkyl, more typically (C8-C22)alkyl, and p is an integer of from 1 to 10. In one embodiment, R3 is (C8-C18)alkyl. In one embodiment, R3 is (C8-C16)alkyl. In yet another embodiment, R3 is (C8-C14)alkyl.

Suitable alkylpolyglucosides include, for example, (C8-C10)alkylpolyglucoside. In another embodiment, the alkylpolyglucosides is a (C8-C12)alkylpolyglucoside.

In one embodiment, the compatibilizing component comprises at least one poly(oxy-1,2-ethanediyl)-alpha-C₆₋₂₂alkyl-omega-hydroxy phosphate (or sulfate) and/or salts thereof. In one embodiment, the poly(oxy-1,2-ethanediyl)-alpha-C₆₋₂₂alkyl-omega-hydroxy phosphate or sulfate is a poly(oxy-1,2-ethanediyl)-alpha-C₈₋₁₆alkyl-omega-hydroxy phosphate, sulfate or salt thereof. In one embodiment, the poly(oxy-1,2-ethanediyl)-alpha-C₆₋₂₂alkyl-omega-hydroxy phosphate, sulfate or salt thereof is a poly(oxy-1,2-ethanediyl)-alpha-C₈₋₁₆alkyl-omega-hydroxy phosphate, sulfate or salt thereof. In one embodiment, the poly(oxy-1,2-ethanediyl)-alpha-C₆₋₂₂alkyl-omega-hydroxy phosphate or sulfate is a poly(oxy-1,2-ethanediyl)-alpha-C₁₀₋₁₂alkyl-omega-hydroxy phosphate or salt thereof. In one embodiment, the poly(oxy-1,2-ethanediyl)-alpha-C₆₋₂₂alkyl-omega-hydroxy phosphate or sulfate is a poly(oxy-1,2-ethanediyl)-alpha-C₁₀₋₁₂alkyl-omega-hydroxy sulfate or salt thereof.

In one embodiment, the poly(oxy-1,2-ethanediyl)-alpha-C₆₋₂₂alkyl-omega-hydroxy phosphate or sulfate is a poly(oxy-1,2-ethanediyl)-alpha-isodecyl-omega-hydroxy phosphate or sulfate. Also, the (oxy-1,2-ethanediyl) portion of the compound is present in about 3 to about 9, preferably about 6, repeating units per molecule.

In one embodiment, the poly(oxy-1,2-ethanediyl)-alpha-C₆₋₂₂alkyl-omega-hydroxy phosphate or sulfate is a poly(oxy-1,2-ethanediyl)-alpha-C₈₋₁₆alkyl-omega-hydroxy phosphate salt, wherein the counterion is an agriculturally acceptable salt. In one embodiment, the counterion is chosen from an amine, an alkali metal, including but not limited to potassium, sodium and the like. Other suitable positively charged counterions include inorganic cations and organic cations, such as for example, calcium cations, magnesium cations, isopropylamine cations, ammonium cations, and tetraalkylammonium cations.

The compatibilizing component as described herein can be applied simultaneously with a high-salt solution or suspension such as a micronutrient solution, a fertilizer, pesticide, herbicide solution, or suspension (e.g., in furrow application). The ability to mix and apply such fertilizers and pesticides to form a stable formulation is very useful to field applications, as it reduces the number of applications across a certain area of crops and the time for application.

Generally, pesticide formulations can be formulated in a variety of ways, two of which are in liquid forms as emulsifiable concentrates (ECs) or suspension concentrates (SCs). Suspension concentrates (SC) are generally characterized as stable suspension of solid pesticide(s) in a fluid usually intended for dilution with water before use. Ideally, the suspension should be stable (i.e. not settle out). Suspension concentrates (SCs) can be diluted with water during or immediately prior to field application, making the SC a convenient and easy to handle application. This application of pesticides in the form of dilute aqueous suspension concentrates, e.g. as a spray, is desired often times because of the ease of application.

Suspension concentrates (SC's) are formulations, wherein the active ingredient is present in the form of finely divided solid particles, which are suspended (dispersed) in a liquid dispersing medium such as water or polyhydric alcohols, wherein the active ingredient is insoluble or only sparingly soluble (typically less than 2000 ppm). Suspension concentrates sometimes contain surface-active compounds (surfactants), such as dispersants and wetting agents for stabilizing the actives (or active ingredient particles) in the dispersing medium.

There are, however, drawbacks in the of SCs, including the settling of particulates during prolonged storage or storage at elevated temperatures, the resistance of settled particles to re-suspension and the formation of crystalline material upon storage. As a consequence, the formulations may be difficult to handle. As another consequence, the bioefficacy may be inconsistent.

Emulsifiable concentrates (EC) is a solution of a pesticide with emulsifying agents in a water insoluble organic solvent which will form an emulsion when added to water. Generally, many pesticides in the form of suspension concentrates are not compatible with surfactant/compatibilizer packages used with emulsifiable concentrates, and vice-versa. There is a need for a universal compatibilizing package, component or composition (can be used interchangeably) that can be utilized with both ECs and SCs.

In one embodiment, the compatibilizing component as described herein can be contacted with at least one pesticide, then at least one liquid fertilizer, which may be of high ionic strength. In another embodiment, the compatibilizing component as described herein can be contacted with at least one liquid fertilizer, which may be of high ionic strength, then subsequently with least one pesticide.

In one embodiment, the fertilizer is a 10-34-0 fertilizer. In another embodiment, the fertilizer is a 6-12-2 fertilizer. The fertilizer can optionally include one or more of sulfur, boron and another micronutrient. In some embodiments, the nitrogen source is in the form of urea or an agriculturally acceptable urea salt. In some embodiments, the liquid fertilizer may be in the form of a solution or a suspension. In some embodiments, the agricultural compositions as described herein are stable when mixed together. In some embodiments, as described herein, the agricultural compositions show no signs of sedimentation or flocculation. In some embodiments, as described herein, the agricultural compositions are homogenous mixtures.

In one embodiment, the pesticide is a fungicide. Specifically, the fungicide is a strobilurin. Strobilurins are primarily used in agriculture to protect crops such as field crops, fruits, vegetables, turfgrass, ornamentals, and the like because of their broad spectrum activity, in particular against three major groups of plant pathogenic fungi: Ascomycetes, Basidiomycetes, and Deuteromycetes.

It is believed that strobilurins break down rapidly in light and upon exposure to water and are thus not reliable for disease control, and suffer from other problems that make them challenging to use as fungicides. In particular, in addition to being potentially degraded under aqueous conditions, strobilurins also have limited water solubility, exhibit low soil mobility, and have compatibility issues with a range of secondary additives and other agricultural products (e.g., pesticides) added to a spray tank, pourable or flowable. Because strobilurins have such low water solubility they need to be formulated to disperse in water before they can be applied to a plant or fungus.

Non-limiting examples of strobilurin compounds include: fluoxastrobin, ([pound])-{2-[6-(2-chlorophenoxy)-5-fluoropyrimidin-4-yloxy]phenyl}(5,6-dihydro-I,4,2-dioxazin-3-yl)methanone O-methyloxime; fenamidone, (S)-I-anilino-4-methyl-2-methylthio-4-phenylimidazolin-5-one, azoxystrobin, methyl (E)-2-{2-[6-(2-cyanophenoxy)pyrimidin-4-yloxy]phenyl}-3-methoxyacrylate, picoxystrobin, methyl (f)-3-methoxy-2-[2-(6-trifluoromethyl-2-pyridyloxymethyl)phenyl]acrylate; enestrobin, methyl 2-{2-[3-(4-chlorophenyl)-I-methylallylideneaminooxymethyl]phenyl}-3-methoxyacrylate, pyraclostrobin, methyl N-{2-[I-(4-chlorophenyl)pyrazol-3-yloxymethyl] phenyl}(N-methoxy)carbamate; famoxadone, 3-anilino-5-methyl-5-(4-phenoxyphenyl)-I,3-oxazolidine-2,4-dione, dimoxystrobin, (f)-2-(methoxyimino)-N-methyl-2-[a-(2,5-xylyloxy)-o-tolyl]acetamide, metominostrobin, (f)-2-methoxyimino-N-methyl-2-(2-phenoxyphenyl)acetamide, orysastrobin, 2[(f)-methoxyimino]-2-[(3f,6f)-2-{5-[(f)-methoxyimino]-4,6-dimethyl-2,8-dioxa-3,7-diazanona-3,6-dienyl}phenyl]-A/-methylacetamide; kresoxim-methyl, methyl ([pound])-methoxyimino[2-(o-tolyloxymethyl)phenyl]acetate; trifloxystrobin, and methyl (f)-methoxyimino-{(f)-a-[I-(a,a,a-trifluoro-m-tolyl)ethylideneaminooxy]-o-tolyl}acetate. In one embodiment, the strobilurin compound is any one or a combination of azoxystrobin, dimoxystrobin, famoxadone, fenamidone, fluoxastrobin, kresoxim-methyl, metaminostrobin, picoxystrobin, pyraclostrobin and trifloxystrobin. In another embodiment, the strobilurin compound is any one or a combination of azoxystrobin, picoxystrobin, pyraclostrobin and trifloxystrobin. In another embodiment, the strobilurin compound is any one or a combination of azoxystrobin and pyraclostrobin.

In some embodiments, the stable agricultural composition described herein can be applied to one part of a plant. In one embodiment, the composition of the present invention resists sedimentation or separation under low shear stress storage conditions yet is pumpable under elevated shear stress condition. In one such embodiment, the composition of the present invention exhibits a viscosity of from about 1 to about 1000 Pa·s, more typically from 5 to about 800 Pa·s, even more typically from about 10 to about 500 Pa·s, at a shear rate of less than or equal to 0.01 s⁻¹ and exhibits a viscosity that is less than the viscosity exhibited at a shear rate of less than or equal to 0.01 s⁻¹, typically a viscosity of less than 10 Pa·s, more typically from about 0.1 to less than 10 Pa·s, and even more typically from about 0.1 to less than 5 Pa·s, at a shear rate of greater than or equal to 10 s⁻¹, more typically, greater than or equal to 100 s⁻¹.

In one embodiment, the polymer exhibits a weight average molecular weight of greater than about 1,000,000 g/mol, more typically greater than about 2,000,000 g/mol to about 20,000,000 g/mol, more typically to about 10,000,000 g/mol.

In one embodiment, the composition of the present invention further comprises a surfactant. As used herein the term “surfactant” means a compound that is capable of lowering the surface tension of water, more typically, a compound selected from one of five classes of compounds, that is, cationic surfactants, anionic surfactants, amphoteric surfactants, zwitterionic surfactants, and nonionic surfactants, as well as mixtures thereof.

Suitable cationic surfactants are known in the art, and include, for example, amine salts, such as, ethoxylated tallow amine, cocoalkylamine, and oleylamine, quaternary ammonium compounds such as cetyl trimethyl ammonium bromide, myristyl trimethyl ammonium bromide, stearyl dimethyl benzyl ammonium chloride, lauryl/myristryl trimethyl ammonium methosulfate, stearyl octyldimonium methosulfate, dihydrogenated palmoylethyl hydroxyethylmonium methosulfate, isostearyl benzylimidonium chloride, cocoyl benzyl hydroxyethyl imidazolinium chloride, cocoyl hydroxyethylimidazolinium, and mixtures thereof.

In one embodiment, the composition of the present invention comprises, based on 100 pbw of the composition, from greater than 0 to about 80 pbw, more typically from about 10 to about 80 pbw, and even more typically, from about 30 to about 70 pbw, of surfactant.

In one embodiment, the composition of the present invention comprises, based on weight of the composition, from 0 to about 75 wt % of surfactant. In another embodiment, the composition of the present invention comprises, based on weight of the composition, from 2 to about 75 wt % of surfactant. In another embodiment, the composition of the present invention comprises, based on weight of the composition, from 5 to about 75 wt % of surfactant. In another embodiment, the composition of the present invention comprises, based on weight of the composition, from 10 to about 75 wt % of surfactant. In another embodiment, the composition of the present invention comprises, based on weight of the composition, from 1 to about 60 wt % of surfactant. In another embodiment, the composition of the present invention comprises, based on weight of the composition, from 4 to about 60 wt % of surfactant. In another embodiment, the composition of the present invention comprises, based on weight of the composition, from 10 to about 60 wt % of surfactant.

In another embodiment, the weight ratio of surfactant to polyol (surfactant:polyol) in the compatibilizing component falls within the range of 10:90 to 90:10, respectively. In another embodiment, the weight ratio of surfactant to polyol (surfactant:polyol) in the compatibilizing agent falls within the range of 20:80 to 80:20, respectively. In another embodiment, the weight ratio of surfactant to polyol (surfactant:polyol) in the compatibilizing agent falls within the range of 40:60 to 60:40, respectively. In another embodiment, the weight ratio of surfactant to polyol (surfactant:polyol) in the compatibilizing agent falls within the range of 30:70 to 70:30, respectively. In another embodiment, the weight ratio of surfactant to polyol (surfactant:polyol) in the compatibilizing agent falls within the range of 45:55 to 55:45, respectively.

In one embodiment, the composition of the present invention does not contain any cationic surfactant, anionic surfactant, amphoteric surfactant, zwitterionic surfactant that is a water soluble salt.

In one embodiment, the composition of the present invention comprises a cationic surfactant, anionic surfactant, amphoteric surfactant, or zwitterionic surfactant, such as, for example, sodium lauryl sulfate, that is a water soluble salt. The amount of surfactant that is a water soluble salt is to be included in the total amount of water soluble salt for purposes of determining the total amount of water soluble salt component of the composition of the present invention.

In one embodiment, the composition of the present invention comprises, based on 100 pbw of the composition, from greater than 0 to about 40 pbw, more typically from about 2 to about 30 pbw, and even more typically, from about 5 to about 25 pbw, of water dispersible organic solvent.

The composition of the present invention is typically made by mixing the components of the composition together.

In one embodiment, the composition of the present invention is an agricultural adjuvant composition that stable, has a low viscosity, is easily transportable, is pourable and pumpable under field conditions, and is dilutable with water under agricultural field conditions.

In one embodiment, the composition of the present invention is mixed with adjuvant ingredients, and water to form a dilute pesticide composition for spray application to target pests.

In one embodiment, the composition is a concentrated, dilutable form of an end use composition and further comprises one or more active ingredients, such as, for example, a personal care benefit agent, a pesticidal active ingredient, or a pharmaceutical active ingredient, appropriate to the intended end use. In one embodiment, the concentrate is diluted to form an end use composition, the end use composition is contacted with a target substrate, such as plant foliage, and the water soluble polymer component of the concentrate enhances delivery of the active ingredient onto the substrate.

In one embodiment, the composition of the present invention is prepared on an as needed basis and is sufficiently stable, that is, a quiescent sample of the composition shows no evidence, by visual inspection, of gravity driven separation, such as, separation into layers and/or precipitation of components, such as, for example, incompletely hydrated water soluble polymer, from the liquid medium, within the anticipated time period, for example, one hour, more typically two hours, between preparation and use.

In one embodiment, the composition of the present invention exhibits good storage stability and a quiescent sample of the composition shows no evidence, by visual inspection, of gravity driven separation within a given time, such as, for example, one week, more typically, one month, even more typically 3 months, under given storage conditions, such as, for example, at room temperature.

In one embodiment, the composition of the present invention exhibits good storage stability and a quiescent sample of the composition shows no evidence, by visual inspection, of gravity driven separation within a given time, such as, for example, 24 hours, more typically, four days, even more typically, one week, under accelerated aging conditions at an elevated storage temperature of up to, for example, 54° C., more typically, 45° C.

In one embodiment, the agricultural formulation allows for a stable solution of quadris and headline in 10-34-0 that is stable for a minimum of 2 hours. In one embodiment, the agricultural formulation as described e allows for a stable solution of quadris and headline in 10-34-0 that is stable for a minimum of 1 hour.

In some embodiments, the compatibilizing component, as used in the agricultural formulations as described herein, are utilized at an effective use rate of equal to or less than 5 wt % (by weight of agricultural formulation), of equal to or less than 4.5 wt % (by weight of agricultural formulation), of equal to or less than 4 wt % (by weight of agricultural formulation), of equal to or less than 3.5 wt % (by weight of agricultural formulation), of equal to or less than 3 wt % (by weight of agricultural formulation), or equal to or less than 2.5 wt % (by weight of agricultural formulation). In some embodiments, the compatibilizing component is used at an effective use rate of equal to or less than 4 wt % (by weight of agricultural formulation). In other embodiments, the compatibilizing component is used at an effective use rate of equal to or less than 3 wt % (by weight of agricultural formulation). In other embodiments, the compatibilizing component is used at an effective use rate of equal to or less than 2 wt % (by weight of agricultural formulation).

In further embodiments, the compatibilizing component is used at an effective use rate of equal to or less than 3.3 wt % (by weight of agricultural formulation), used at an effective use rate of equal to or less than 3 wt % (by weight of agricultural formulation), used at an effective use rate of equal to or less than 2.7 wt % (by weight of agricultural formulation), used at an effective use rate of equal to or less than 2.3 wt % (by weight of agricultural formulation), used at an effective use rate of equal to or less than 1.7 wt % (by weight of agricultural formulation), used at an effective use rate of equal to or less than 1.3 wt % (by weight of agricultural formulation), or used at an effective use rate of equal to or less than 1 wt % (by weight of agricultural formulation).

In an alternative embodiment, the compatibilizing component is used at an effective use rate of equal to or less than 0.7 wt % (by weight of agricultural formulation). In an alternative embodiment, the compatibilizing component is used at an effective use rate of equal to or less than 0.3 wt % (by weight of agricultural formulation).

### Experiment 1

Chemical/Physical Properties. The properties of fungicides formulations and fertilizer carriers used in this study are outlined below. Quadris™ (Syngenta) is a commercial product, which comprises Azoxystrobin as its active ingredient in a suspension concentrate. Headline™ (BASF) is a commercial product which comprises pyraclostrobin as an active ingredient in an emulsion concentrate.

TABLE 1

| | Fungicides | | Fertilizer |
|---|---|---|---|
| Property | Quadris | Headline | 10-34-0 |
| Active | Azoxystrobin | Pyraclostrobin | N, P, K |
| Ingredients | | | |
| Formulation | Suspension | Emulsifiable | Salt solution |
| | Concentrate | Concentrate | |
| Density @ | 1.10 g/mL | 1.05 g/mL | 1.40 g/mL |
| 20° C. | | | |

Testing Conditions:

The following Table 2 highlights the use rates of each component for all experiments included here.

TABLE 2

| Component | Use Rate |
|---|---|
| Quadris SC | 9 oz/acre |
| Headline EC | 9 oz/acre |
| 10-34-0 | 3 gal/acre |
| DV-1 | 1 qt/acre |

Procedure

1. First, premix DV-1 at a rate of 1 quart/acre with the rate of fungicide indicated on the product label that suits the specific application needs. DV-1 is comprised of, by weight of composition: 50 wt % of a polyacrylic acid (partial salt) and 50 wt % glycerine. DV-1, as-is, is a yellow to brown liquid, with a density of 1.242 g/mL @ 20° C., a pH of 3.35 @ 1% in water, and is observed to be stable for 1 month at −16, 4, 25, and 54° C. and through daily freeze-thaw cycles

2. Add the premix of DV-1 and fungicide formulation into the preferred fertilizer carrier mixture.

3. Agitate the mixture thoroughly until the solution is homogenous.

4. Observe after 2 hrs.

Incompatibility

It was observed that incompatibility issues arose when fungicide and fertilizer are mixed directly without the addition of DV-1, including inhomogeneity (non-homogenous) and phase separation, as shown in Table 3.

TABLE 3

| Fungicide | Fertilizer | Compatibilizer | Observations/Comments |
|---|---|---|---|
| Quadris | 10-34-0 | None | Not stable, non- |
| | | | homogenous, some |
| | | | flocculation to top. Dark |
| | | | areas interspersed with |
| | | | white areas. |
| Headline | 10-34-0 | None | Not stable, observed |
| | | | phase separation with thin |
| | | | film appearing at top |

The incompatibility symptoms for each fungicide are similar in both fertilizer carriers. Quadris™ flocculates to the top in 10-34-0, and Headline™ EC phase separates, which is believed to be a result of a density gradient and high salt solution.

Following the procedure detailed herein, Quadris™ SC and Headline™ EC were premixed with DV-1 in 10-34-0, and observed in Table 4.

TABLE 4

| Fungicide | Fertilizer | Compatibilizer | Observations/Comments |
|---|---|---|---|
| Quadris | 10-34-0 | DV-1 | Stable, homogenous, |
| | | | whitish appearance |
| | | | throughout |
| Headline | 10-34-0 | DV-1 | Stable, homogenous, |
| | | | whitish appearance |
| | | | throughout |

Table 5 summarizes the approximate timescales of stability for mixtures (stagnant, agitated) before observed separation.

TABLE 5

| | | Fertilizer Carrier |
|---|---|---|
| | | 10-34-0 |
| Fungicide | Quadris SC + | 6 hours |
| Formulations | DV-1 | |
| premixed with | Headline EC + | 4 hours |
| DV-1 | DV-1 | |

However, the mixtures were easily re-homogenized by additional agitation. In the context of the inventions, stability means that the mixture appears homogenous for at least 2 hours before observed separation, which were easily re-homogenized by re-agitation.

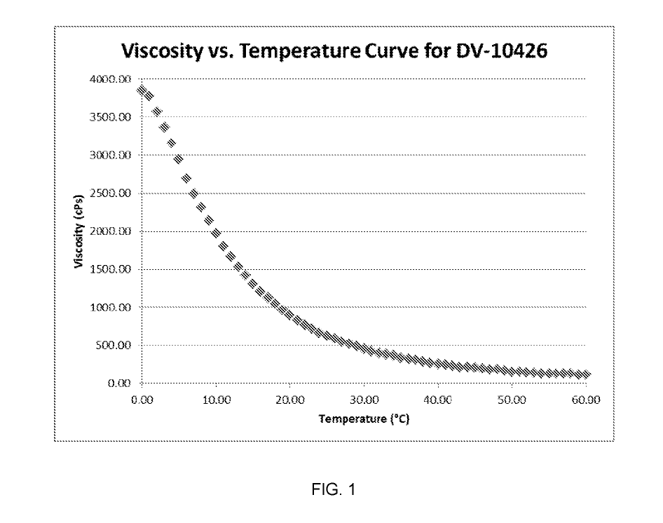

Further, DV-1 shows stability over a wide range of temperatures, including as low as −16° C. It is also relatively easy to handle even at low temperatures. As Shown in FIG. 1, a viscosity vs. temperature plot shows the profile of this material from 0-60° C.

### Experiment 2

All the work completed uses the following use rates for Quadris SC and 10-34-0.

TABLE 6
Use rate of fungicide and started fertilizer use for all the
testing

| Component | Use rate |
|---|---|
| Quadris SC | 9 oz/acre |
| 10-34-0 | 3 gal/acre |

All formulations were prepared using a glass jar, magnetic stir bar and plate.

Based on the scouting work Candidate A and Candidate B were prepared and analyzed. Table 7 summarizes the composition.

TABLE 7

| Component | Candidate A | Candidate B |
|---|---|---|
| Glycerin | 60.0% | 60.0% |
| Water | 20.0% | 20.0% |
| poly(oxy-1,2-ethanediyl)-alpha- | 20.0% | — |
| isodecyl-omega-hydroxy | | |
| phosphate | | |
| alkylpolyglucoside | — | 20.0% |

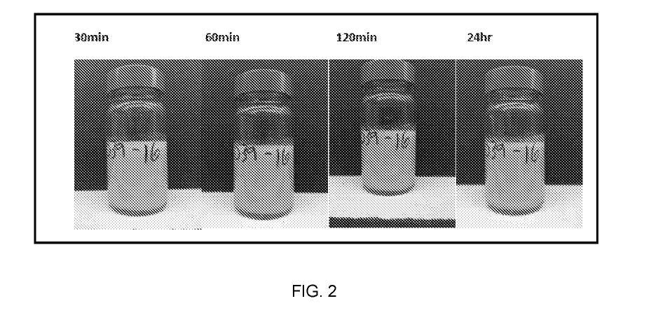

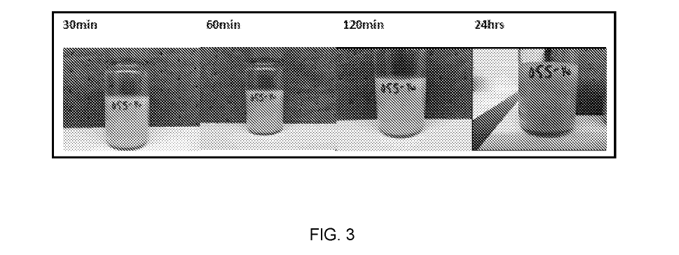

Candidate A, with poly(oxy-1,2-ethanediyl)-alpha-isodecyl-omega-hydroxy phosphate exhibits performance giving 24 hour compatibility stability, as seen in FIG. 2. While candidate B, incorporating alkylpolyglucoside, shows good compatibility for 2-3 hours, as shown in FIG. 3.

Compatibility aid capacity was tested by making a premix of Quadris SC with the compatibility aid. Then the premix was added to 10-34-0 and stability monitored for a period of 24 hours.

A 3% use rate was used for the scouting work and selection of the different candidate. However further testing was performed with the lead candidates at lower rates to determine the breaking point were compatibility is no longer acceptable.

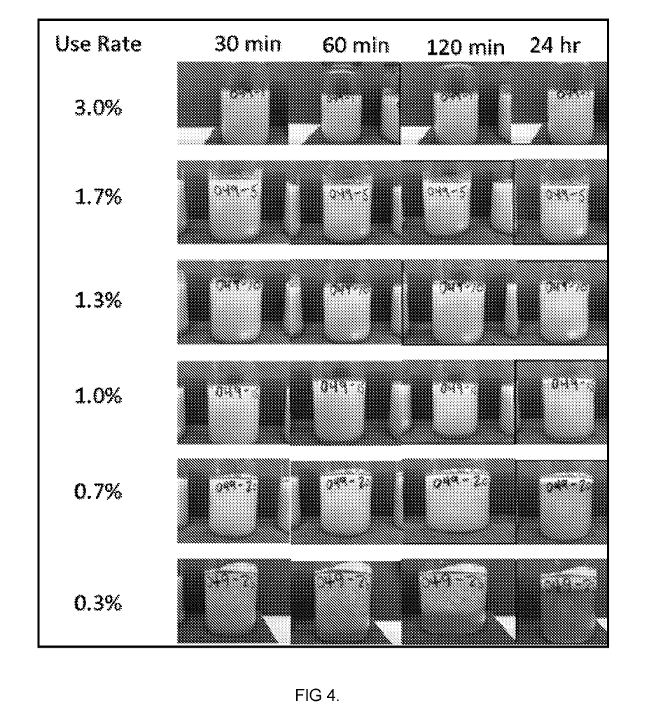

FIG. 4 illustrates the results of Candidate A at different use rates (0.3 to 3%). It was observed that 0.7 to 1% use rate is needed if 2 hours compatibility is requested or 1.7% if 12 to 24 hours is needed.

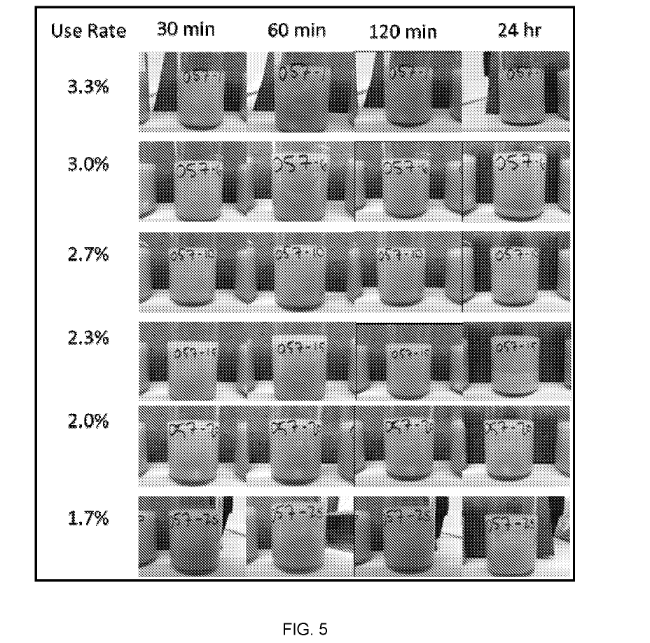

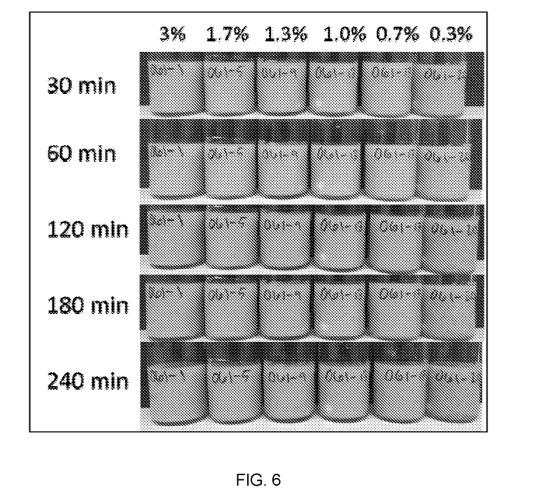

FIG. 5 shows the results of Candidate B at different use rates (from 1.7 up to 3.3%). It was observed that good compatibility is observed up to 2 hours for all of them, however at 24 hours is completely separated. Work was completed to find out the lowest use rate that can be used for this chassis for a 2 hour compatibility timeline, rates down to 0.3% were tested, as seen in FIG. 6. Samples 3% and 1.7% were stable for the 2 hours. Minor flocculation was observed for use rates 1.3-0.7% at 2 hours' time mark. While 0.3% use rate flocculated before the 2 hours.

TABLE VI
Physical Properties summary for both candidates

| Property | Candidate A | Candidate B |
|---|---|---|
| Appearance | Light to dark amber | Light to dark amber |
| | solution | solution |
| pH (1% dilution in | 2.23 | 6.05 |
| water) | | |
| Stability | Phase separation at | Stable at −16° C., 4° C., |
| | high temperature | 25° C., 45° C., 54° C. and FT |
| | | for 3 months |
| Density, g/mL | 1.196 | 1.189 |
| Viscosity, SC4-18 at | 369.5 cps | 62.99 cps |
| 5 RPM | | |
| Use rate (2 hr | 1% | 1.7% |
| compatibility) | | |

Candidates A and B compatibilized Quadris with the 10-34-0. Candidate A compatibilized for up to 24 hours. Candidate B exhibited longer-term stability; however it was observed to compatibilize the fungicide and fertilizer for only 2-3 hours.

1. An aqueous pesticide composition comprising:
at least one strobilurin compound as a suspension concentrate or emulsion concentrate;
at least one fertilizer; and
a compatibilizing component comprising (i) at least one polyol, (ii) at least one carboxylic acid-containing polymer (e.g., polyacrylic acid or salt thereof), (iii) at least one alkylpolyglucoside or (iv) at least one poly(oxy-1,2-ethanediyl)-alpha-C₆₋₂₂alkyl-omega-hydroxy phosphate or salt thereof.

2. The composition of claim 1 wherein the carboxylic-acid containing polymer is polyacrylic acid or salt thereof.

3. The composition of claim 1 wherein the polyol is selected from glycerine, ethylene glycol or propylene glycol.

4. The composition of claim 1 wherein the at least one poly(oxy-1,2-ethanediyl)-alpha-C₆₋₂₂alkyl-omega-hydroxy phosphate or salt thereof is poly(oxy-1,2-ethanediyl)-alpha-isodecyl-omega-hydroxy phosphate or salt thereof.

5. The composition of claim 1 wherein the strobilurin compound is selected from azoxystrobin or pyraclostrobin.

6. The composition of claim 1 wherein the strobilurin compound is selected from azoxystrobin, dimoxystrobin, famoxadone, fenamidone, fluoxastrobin, kresoxim-methyl, metaminostrobin, picoxystrobin, pyraclostrobin and trifloxystrobin.

7. A stable aqueous pesticide composition comprising:
a compatibilizing component selected from:
(A) at least one polyol,
(B) a combination of at least one polyol and at least one alkylpolyglucoside
(C) a combination of at least one polyol and the at least one poly(oxy-1,2-ethanediyl)-alpha-C₆₋₂₂alkyl-omega-hydroxy phosphate or salt thereof;
at least one pesticide; and
at least one fertilizer.

8. The composition of claim 7 wherein the pesticide is selected from a fungicide, an insecticide or a herbicide.

9. The composition of claim 7 wherein the at least one poly(oxy-1,2-ethanediyl)-alpha-C₆₋₂₂alkyl-omega-hydroxy phosphate or salt thereof is poly(oxy-1,2-ethanediyl)-alpha-isodecyl-omega-hydroxy phosphate or salt thereof.

10. The composition of claim 7 wherein the pesticide is a strobilurin compound.

11. The composition of claim 7 wherein the polyol is selected from glycerine, ethylene glycol or propylene glycol.

12. The composition of claim 7 wherein the polyol is glycerine.

13. The composition of claim 10, wherein the strobilurin compound is selected from azoxystrobin or pyraclostrobin.

14. The composition of claim 10 wherein the strobilurin compound is selected from azoxystrobin, dimoxystrobin, famoxadone, fenamidone, fluoxastrobin, kresoxim-methyl, metaminostrobin, picoxystrobin, pyraclostrobin and trifloxystrobin.

15. A method of making an aqueous agricultural composition comprising contacting a compatibilizing component with a pesticide and a fertilizer, wherein the compatibilizing component comprises:
(A) at least one polyol,
(B) a combination of the at least one polyol and at least one alkylpolyglucoside
(C) a combination of the at least one polyol and at least one poly(oxy-1,2-ethanediyl)-alpha-C₆₋₂₂alkyl-omega-hydroxy phosphate or salt thereof;
whereby the aqueous agricultural composition is stable.

16. The method of claim 15 wherein the at least one poly(oxy-1,2-ethanediyl)-alpha-C₆₋₂₂alkyl-omega-hydroxy phosphate or salt thereof is poly(oxy-1,2-ethanediyl)-alpha-isodecyl-omega-hydroxy phosphate or salt thereof.

17. The method of claim 15 wherein the pesticide is a strobilurin compound.

18. The method of claim 15 wherein the polyol is selected from glycerine, ethylene glycol or propylene glycol.

19. The method of claim 15 wherein the polyol is glycerine.

20. The method of claim 17 wherein the strobilurin compound is selected from azoxystrobin or pyraclostrobin.

21. The method of claim 17 wherein the strobilurin compound is selected from azoxystrobin, dimoxystrobin, famoxadone, fenamidone, fluoxastrobin, kresoxim-methyl, metaminostrobin, picoxystrobin, pyraclostrobin and trifloxystrobin.
